(19) United States
(12) Patent Application Publication
(10) Pub. No.: US 2007/0065720 A1
(43) Pub. Date: Mar. 22, 2007

(54) Negative electrode for lithium ion secondary battery and lithium ion secondary battery prepared by using the same

(76) Inventors: Masaki Hasegawa, Osaka (JP); Yasuhiko Bito, Osaka (JP)

Correspondence Address: MCDERMOTT WILL & EMERY LLP, 600 13TH STREET, N.W., WASHINGTON, DC, 20005-3096, US

(21) Appl. No.: 11/524,956

(22) Filed: Sep. 22, 2006

(30) Foreign Application Priority Data
Sep. 22, 2005 (JP) 2005-275709

(51) Int. Cl. H01M 4/62; H01M 4/58; H01M 4/40

(52) U.S. Cl. 429/217; 429/231.95

(57) ABSTRACT

A negative electrode for a lithium ion secondary battery includes a negative electrode active material layer. The negative electrode active material layer contains a negative electrode active material capable of reversibly absorbing and desorbing lithium, and a binder. The binder comprises at least one polymer selected from the group consisting of polyacrylic acid and polymethacrylic acid, and the polymer comprises an acid anhydride group.

### FIELD OF THE INVENTION

The present invention relates to a lithium ion secondary battery, and, particularly, to the negative electrode thereof.

### BACKGROUND OF THE INVENTION

Lithium ion secondary batteries can provide high voltage and high energy density. Thus, lithium ion secondary batteries have recently been used, for example, as the main power source for mobile communications devices and portable electronic devices. Meanwhile, these devices have been becoming increasingly smaller in size and higher in performance, and batteries used as the power source of such devices are required to offer higher performance. Hence, extensive research is being conducted.

With respect to positive and negative electrode active materials for use in lithium ion secondary batteries, various materials have been proposed and researched. For example, carbon materials and aluminum alloys have been commercialized as negative electrode active materials. Among such negative electrode active materials, carbon materials are widely used since they provide the highest performance. The capacity of currently commercialized negative electrode active materials comprising carbon materials is close to the theoretical capacity of graphite (approximately 370 mAh/g). It is therefore very difficult to further heighten the energy density by improving carbon materials.

In order to further heighten the capacity of lithium ion secondary batteries, various new materials have been examined as negative electrode active materials. For example, Japanese Laid-Open Patent Publication No. Hei 07-29602 proposes using metals, such as silicon (Si) and tin (Sn), that are capable of absorbing and desorbing lithium, or alloys containing these metals as negative electrode active materials.

A negative electrode containing such a negative electrode active material is prepared, for example, by applying an electrode mixture slurry that contains a negative electrode active material and a binder onto a current collector and drying it. Hence, the performance of the binder, which bonds the active material particles together and bonds the active material to the current collector, has a large effect on the performance of the negative electrode. When the binder has low adhesive properties, the adhesion of the active material particles and the adhesion of the active material to the current collector become poor, thereby resulting in degradation of current collecting characteristics. Degradation of current collecting characteristics can lead to degradation of electrode performance.

Also, the above-mentioned Si and Sn or alloys thereof undergo large volume changes when they absorb and desorb lithium in charge/discharge reaction. Thus, the use of such a material as a negative electrode active material involves the following problems. During charge, lithium is absorbed in the negative electrode, so the volume of the negative electrode active material increases and the negative electrode active material layer also expands. On the other hand, during discharge, lithium is released, so the volume of the negative electrode active material decreases and the negative electrode active material layer also shrinks. As a result, a large stress is exerted to the binder contained in the active material layer. Therefore, the binder is required to have strong adhesive properties.

To solve such problems, various binders have been examined, and, for example, Japanese Laid-Open Patent Publication No. Hei 09-289022 proposes using a polymer such as polyacrylic acid as the binder.

Generally, a binder exhibits its adhesive properties when the functional group contained in the binder, such as a carboxyl group or a hydroxyl group, adsorbs to the surface of an active material. Polyacrylic acid and polymethacrylic acid are polymers having a large number of carboxyl groups, so they have strong adhesive properties. Further, since these carboxylic acids are chemically stable, they exhibit good characteristics as binders. Therefore, it is believed that the use of such a polymer as a binder can provide relatively good battery performance even when a metal powder such as Si or Sn or an alloy powder containing Si or Sn is used as a negative electrode active material.

However, since the carboxyl group is a functional group that is highly hydrophilic, it is highly likely that water is adsorbed to the carboxyl group. Thus, when a binder containing a large number of carboxyl groups is used to produce an electrode plate, the electrode plate contains a large amount of residual water. Particularly in the case of a lithium ion secondary battery using a non-aqueous electrolyte, the residual water in the battery causes side reactions, such as decomposition of the solute contained in the non-aqueous electrolyte, gas evolution, formation of a coating film on the electrode surface. Such side reactions can cause battery bulging and/or degradation of battery performance, which can in turn cause damage to the device powered by the battery or other problems.

### BRIEF SUMMARY OF THE INVENTION

The negative electrode for a lithium ion secondary battery according to the present invention has a negative electrode active material layer that contains a negative electrode active material capable of reversibly absorbing and desorbing lithium, and a binder. The binder comprises at least one polymer selected from the group consisting of polyacrylic acid and polymethacrylic acid, and the polymer contains an acid anhydride group. The acid anhydride group is formed by condensation of two carboxyl groups.

When such a polymer is used as the binder, good adhesive properties can be obtained. Further, since the binder has low hydrophilicity, the adsorption of water to the binder can be suppressed. Accordingly, by using the negative electrode of the present invention, it is possible to improve the battery performance of lithium ion secondary batteries.

The negative electrode active material preferably contains at least one element selected from the group consisting of Si and Sn. The negative electrode active material may be at least one selected from the group consisting of Si simple substance (substance composed simply of Si) and Sn simple substance (substance composed simply of Sn). The negative electrode active material may comprise at least one selected from the group consisting of SiOₓ where 0<x<2 and SnO_{y} where 0<y<2. The negative electrode active material may comprise an alloy material containing Si and at least one selected from the group consisting of Ti, Fe, Co, Ni and Cu. When the negative electrode active material comprises an alloy material, the alloy material preferably has a TiSi₂ phase and a Si phase.

The present invention also relates to a lithium ion secondary battery including the above-mentioned negative electrode, a positive electrode, a separator, and a non-aqueous electrolyte.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a graph showing an infrared absorption spectrum of polyacrylic acid that was heat treated at 60° C.;

FIG. 2 is a graph showing an infrared absorption spectrum of polyacrylic acid that was heat treated at 110° C.;

FIG. 3 is a graph showing an infrared absorption spectrum of polyacrylic acid that was heat treated at 190° C.; and

FIG. 4 is a schematic longitudinal sectional view of a non-aqueous electrolyte secondary battery prepared in an Example of the present invention.

### DETAILED DESCRIPTION OF THE INVENTION

The lithium ion secondary battery of the present invention includes a positive electrode, a negative electrode, a separator interposed between the positive electrode and the negative electrode, and a non-aqueous electrolyte.

The negative electrode has a negative electrode active material layer. The negative electrode active material layer comprises a negative electrode active material capable of reversibly absorbing and desorbing lithium, and a binder.

The binder contained in the negative electrode comprises at least one polymer selected from the group consisting of polyacrylic acid and polymethacrylic acid, and the polymer contains an acid anhydride group.

The carboxyl group is a functional group that is highly hydrophilic and, therefore, it is highly likely that the polymer contains residual water. This water cannot be fully removed at a drying temperature of approximately 100° C. Also, even if a high-temperature heat-treatment of 200° C. or more is applied to remove water, the polymer is decomposed, thereby resulting in degradation of performance of the binder.

According to the present invention, in at least one binder of polyacrylic acid and polymethacrylic acid, two carboxyl groups are condensed together, as shown below. Therefore, the polymer has low hydrophilicity and contains less residual water.

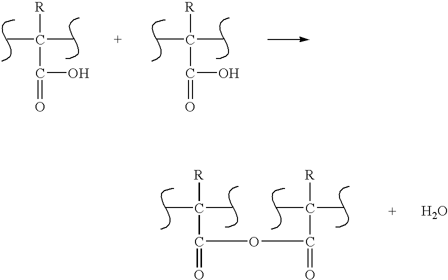

where R is H or CH₃.

Further, due to the condensation of the carboxyl groups, for example, polymers are cross-linked together, so that the strength of the binder is increased. As a result, the performance of the binder is improved. It should be noted that the cross-linking of carboxyl groups due to condensation does not require steps of adding a cross-linking agent and controlling the cross-linking reaction, unlike the cross-linking reaction of polymers by a cross-linking agent. Further, there is no need to consider the effect of the cross-linking agent on electrode materials. The two carboxyl groups constituting the acid anhydride group may be present in the same polymer molecule or in different polymer molecules.

When such a polymer is used as the binder, excellent adhesive properties can be obtained, and the adsorption of water to the binder is suppressed since the hydrophilicity of the binder itself can be reduced. Accordingly, the use of the negative electrode of the present invention makes it possible to improve battery performance.

When polyacrylic acid and polymethacrylic acid comprising condensed carboxyl groups are analyzed by infrared absorption spectroscopy, an absorption peak attributable to the structure (—CO—O—CO—) formed by the condensation of the carboxyl groups appears in the range of 980 cm⁻¹ to 1100 cm⁻¹. Hence, by analyzing the intensity of the absorption peak appearing in the range of 980 cm⁻¹ to 1100 cm⁻¹ in an infrared absorption spectrum, formation of an acid anhydride group can be confirmed.

In the present invention, the ratio of the condensed carboxyl groups is preferably 20 to 80% of the total. For example, the ratio of the transmittance of the absorption peak that appears in the above-mentioned range when the carboxyl groups are condensed together to that when the carboxyl groups are not condensed is preferably 20% to 60%.

If the ratio of the condensed carboxyl groups is lower than 20%, such condensation does not increase the strength of the polymer so much, so that the adhesive properties of the polymer are not improved. If the ratio of the condensed carboxyl groups is higher than 80%, the amount of uncondensed carboxyl groups is small, so that the adhesion of the active material particles and the adhesion of the active material to the current collector are impaired.

The binder comprising such a polymer can produce sufficient adhesive effect even when it is used in combination with a negative electrode active material that comprises a material containing Si or Sn, which has high capacity but expands and contracts significantly. Specifically, the binder comprising such a polymer has high adhesive properties. Therefore, even if it is used in combination with such an active material that expands and contracts significantly during charge/discharge, it can sufficiently bond the active material particles together and/or bond the active material to the current collector.

The negative electrode active material may be Si simple substance, Sn simple substance, a compound containing Si or Sn, a salt thereof, an alloy thereof, and an oxide thereof. Specific examples of negative electrode active materials include Si, Sn, SiOₓ where 0<x<2, SnO_{y} where 0<y<2, Si alloys, and Sn alloys. In SiOₓ, the molar ratio x of oxygen to silicon is preferably 0.01 to 1. In SnO_{y} where 0<y<2, the molar ratio y of oxygen to tin is preferably 0.01 to 1.

Among them, the preferable negative electrode active material is an alloy material comprising: Si or Sn; and at least one element selected from the group consisting of Ti, Fe, Co, Ni, and Cu. Particularly, when an alloy comprises a TiSi₂ phase and a Si phase, the alloy has a phase contributing to charge/discharge (Si phase) and a phase not contributing to charge/discharge (TiSi₂ phase). Thus, the active material particle surface also has these two phases, and the phase not contributing to charge/discharge undergoes small changes in surface shape even during charge/discharge and is therefore capable of maintaining the strong adhesion to the binder. Hence, by using such an alloy material and a polymer as described above in combination, it is possible, for example, to sufficiently suppress gas evolution and significantly improve the cycle characteristics of the battery.

When the negative electrode active material is an alloy comprising a TiSi₂ phase and a Si phase, the Ti/Si atomic ratio is preferably 1:17 to 20:53. By setting the Ti/Si atomic ratio in this range, it is possible to improve capacity while improving cycle characteristics. If the atomic ratio of Si to Ti is greater than 17, the cycle characteristics may degrade. If the atomic ratio of Si to Ti is less than 53/20, the capacity may decrease.

The amount of the polymer contained in the negative electrode active material layer is preferably 2 to 20 parts by weight per 100 parts by weight of the negative electrode active material. If the amount of the polymer exceeds 20 parts by weight, the polymer may impede the electrochemical reaction of the negative electrode active material. If the amount of the polymer is less than 2 parts by weight, the adhesive properties degrade, which may result in degradation of electrode performance.

The average molecular weight of the polymer is preferably 50000 to 1500000. If the average molecular weight of the polymer is less than 50000, the strength of the polymer decreases, which may result in degradation of adhesive properties. For example, when the negative electrode is prepared by using a negative electrode mixture slurry, if the average molecular weight of the polymer exceeds 1500000, the negative electrode mixture slurry has high viscosity, so that it is difficult to form a negative electrode from such slurry.

The negative electrode may be composed only of a negative electrode active material layer, or composed of a negative electrode current collector and a negative electrode active material layer carried on the negative electrode current collector.

For example, a negative electrode composed of a current collector and an active material layer carried thereon is prepared by a method including the steps of: (a) preparing an electrode mixture slurry that contains a negative electrode active material, a binder, and a dispersion medium; (b) applying the electrode mixture slurry onto a current collector and drying it to form a negative electrode active material layer; and (c) heat-treating the negative electrode active material layer at a predetermined temperature.

In the step (c), the heat-treatment of the negative electrode active material layer (i.e., the binder) is preferably performed in an inert atmosphere or a vacuum at temperatures of 150° C. or more and less than 200° C. The inert atmosphere may be composed of gas such as N₂ gas or Ar gas.

By applying the heat-treatment at such temperatures, the carboxyl groups can be readily condensed together. If the temperature of the heat-treatment is less than 150° C., condensation reaction is unlikely to proceed. If the temperature of the heat-treatment is 200° C. or more, the carboxyl groups are decomposed, so that the adhesive properties of the binder degrade. Particularly when the negative electrode active material is composed only of Si simple substance or Sn simple substance or comprises an alloy material containing Si or Sn, it undergoes large volume changes during charge/discharge. Therefore, the resultant deterioration of adhesive properties due to decomposition of the carboxyl groups can cause degradation of battery performance.

The duration of the heat-treatment is preferably 4 to 12 hours. If the duration of the heat-treatment is less than 4 hours, the condensation reaction becomes insufficient and the ratio of the condensed carboxyl groups decreases. If the duration of the heat-treatment is longer than 12 hours, the condensation reaction becomes excessive, and the ratio of the condensed carboxyl groups increases. As a result, the adhesive properties of the polymer degrade.

Preferably, the dispersion medium used to prepare the electrode mixture slurry is capable of dissolving the polymer. Examples of such dispersion mediums include water and alcohol such as ethanol.

When a hydrophilic polymer such as polyacrylic acid is used, water can be used to prepare an electrode mixture slurry. However, an acid anhydride group obtained by condensing part of the carboxyl groups contained in such a polymer has low hydrophilicity. It is thus difficult to dissolve a polymer containing an acid anhydride group in water. Therefore, it is preferred that an electrode mixture slurry containing such a polymer be heat-treated after it is applied to a current collector.

It should be noted that the drying of an electrode mixture slurry is conventionally performed at approximately 110° C. It is believed that at such drying temperature, condensation of carboxyl groups does not occur.

The amount of the polymer contained in the electrode mixture slurry is preferably 2 to 20 parts by weight per 100 parts by weight of the negative electrode active material.

With respect to the material of the negative electrode current collector, any material that is an electronic conductor and does not cause a chemical change inside the battery may be used without any particular limitation. Examples of such materials include stainless steel, nickel, copper, titanium, carbon, and conductive resin. It is also possible to use a copper sheet or a stainless steel sheet that is coated with carbon, nickel, or titanium as a negative electrode current collector. Particularly, in terms of costs, workability, and stability, the material of the negative electrode current collector is preferably copper or a copper alloy.

Further, the negative electrode current collector may be composed of a resin material that is not electronically conductive and a conductive layer formed on the surface thereof. Examples of such resin materials which may be used include polyethylene terephthalate, polyethylene naphthalate, and polyphenylene sulfide. Examples of materials of the conductive layer include stainless steel, nickel, copper, titanium, and carbon.

Even when the negative electrode active material layer contains a conductive agent, the binder comprising a polymer as described above also exhibits an excellent adhesive effect in the same manner as the above. The conductive agent is not particularly limited and may be any electronically conductive material. Examples of conductive agents include graphites such as natural graphite (e.g., flake graphite), artificial graphite, and expanded graphite, carbon blacks such as acetylene black, ketjen black, channel black, furnace black, lamp black, and thermal black, conductive fibers such as carbon fibers and metal fibers, metal powders such as copper and nickel, and organic conductive materials such as polyphenylene derivatives. They may be used singly or in combination of two or more of them. Among them, carbon blacks, which are in the form of fine particles and highly conductive, are particularly preferred.

The amount of the conductive agent added is not particularly limited. However, generally, the amount is preferably 2 to 30 parts by weight per 100 parts by weight of the negative electrode active material. These conductive agents may also be used as conductive agents to be added to the positive electrode.

The material of the positive electrode current collector may be any material that is well-known in the art. An example of such material is aluminum.

The positive electrode active material layer can include, for example, a positive electrode active material, a binder and a conductive agent. The positive electrode active material and the binder to be added to the positive electrode may be any material that is well-known in the art. The positive electrode active material may be, for example, a lithium-containing composite oxide such as lithium cobaltate. The binder to be added to the positive electrode may be, for example, polytetrafluoroethylene or polyvinylidene fluoride. As the conductive agent to be added to the positive electrode, essentially the same conductive agents as those for the negative electrode may be used.

The non-aqueous electrolyte comprises a non-aqueous solvent and a solute dissolved therein. Examples of non-aqueous solvents include, but are not limited to, ethylene carbonate, propylene carbonate, dimethyl carbonate, diethyl carbonate, and methyl ethyl carbonate. These non-aqueous solvents may be used singly or in combination of two or more of them.

Examples of solutes include LiPF₆, LiBF₄, LiCl₄, LiAlCl₄, LiSbF₆, LiSCN, LiCl, LiCF₃SO₃, LiCF₃CO₂, Li(CF₂SO₂)₂, LiAsF₆, LiN(CF₃SO₂) 2, LiB₁₀Cl₁₀, and imides.

The material of the separator may be any material that is well-known in the art. Such materials include polyethylene, polypropylene, a mixture of polyethylene and polypropylene, and a copolymer of ethylene and propylene.

The above-mentioned effects of the binder are obtained when an electrode sheet is produced by applying an electrode mixture slurry containing an active material powder, a conductive agent, a binder, and a dispersion medium onto a current collector or when an electrode is produced by molding a powder mixture of an active material powder, a binder and the like.

The shape of the lithium ion secondary battery including the above-mentioned negative electrode is not particularly limited and may be, for example, coin-shaped, sheet-shaped, or prismatic. Also, the lithium ion secondary battery may be a large battery that is used, for example, in an electric vehicle. The electrode assembly of the lithium ion secondary battery of the present invention may be of the layered-type or the wound-type.

The present invention is hereinafter described more specifically by way of Examples. However, the present invention is not limited to these Examples.

### EXAMPLE 1

(Batteries 1 to 6)

(Preparation of Negative Electrode)

An alloy powder comprising Ti and Si, which serves as a negative electrode active material, was mixed with acetylene black serving as a conductive agent and an aqueous solution containing polyacrylic acid (weight-average molecular weight 150000) (available from Wako Pure Chemical Industries, Ltd., polyacrylic acid concentration: 25% by weight) serving as a binder. The amount of polyacrylic acid was 14 parts by weight per 100 parts by weight of the negative electrode active material. The amount of the polyacrylic acid was 10% by weight of all the solid content. The amount of the conductive agent was 29 parts by weight per 100 parts by weight of the negative electrode active material.

A suitable amount of water (dispersion medium) was added to the resultant mixture, which was then fully mixed to form a negative electrode mixture slurry.

The slurry was applied onto both sides of a negative electrode current collector, dried and rolled to produce a negative electrode sheet. The negative electrode current collector used was a rolled copper foil of 12 μm in thickness.

In order to condense carboxyl groups together, the negative electrode sheet was heat-treated in a vacuum at 60° C., 110° C., 150° C., 190° C., 200° C. or 210° C. for 6 hours, to obtain negative electrodes “a” to “f”. These negative electrodes had a thickness of 100 μm.

From each of the heat-treated negative electrodes, the negative electrode active material layer was removed and then crushed into power form. The resultant powder was mixed with KBr and molded to obtain a measurement sample. Using this sample, infrared absorption spectroscopic analysis of polyacrylic acid was performed. The instrument used to perform this analysis was AVATER 360/Continiuum available from Nicolet Instrument Corporation.

It is known that polyacrylic acid and polymethacrylic acid comprising condensed carboxyl groups have an infrared absorption peak in the range of 980 cm⁻¹ to 1100 cm⁻¹. It is believed that this absorption peak is attributable to the structure formed by the above-mentioned condensation.

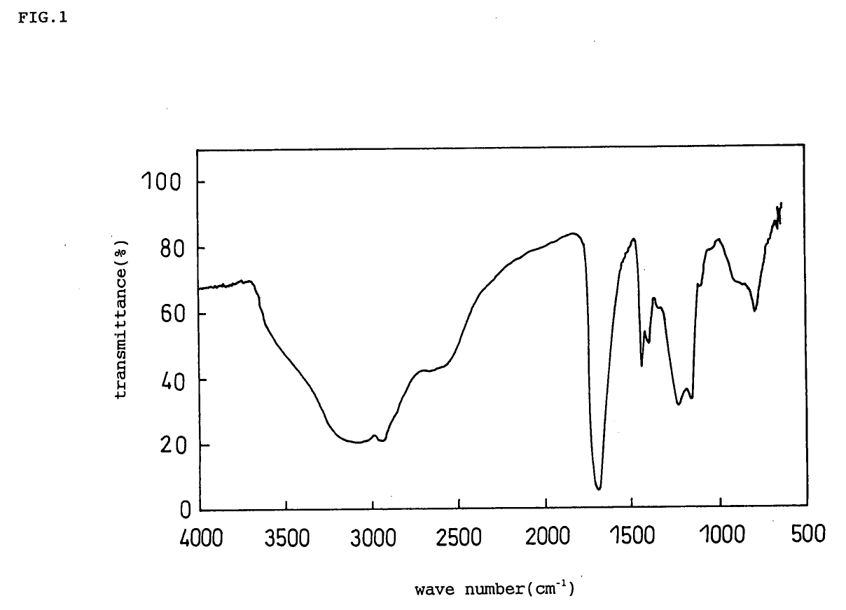

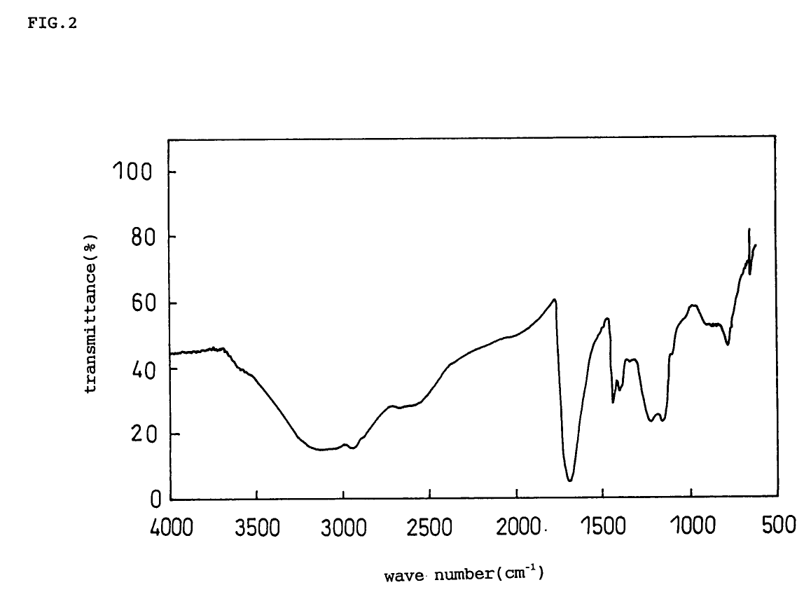

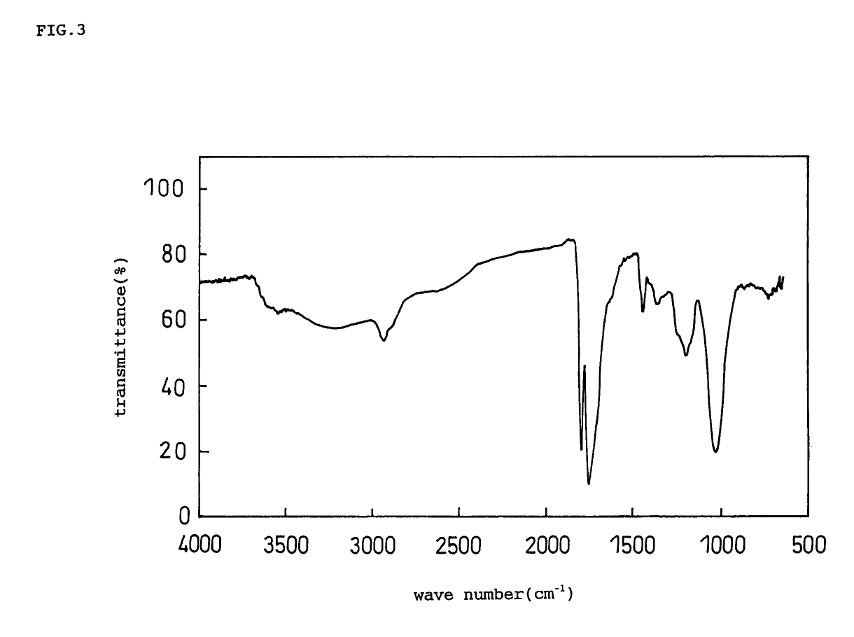

The results of the analyses confirmed that when the heat-treatment is performed at 150° C. or more, an absorption peak appears in the range of 980 cm⁻¹ to 1100 cm⁻¹, thereby showing that an acid anhydride group(s) is formed. As representative infrared absorption spectra, FIGS. 1 to 3 show infrared absorption spectra of polyacrylic acids that were heat-treated by heating negative electrode sheets at 60° C., 110° C., and 190° C., respectively.

In the infrared absorption spectra of the binders that were heat-treated at 150° C. or higher, the transmittance of the absorption peak that appeared in the above-mentioned range when the carboxyl groups were condensed together was 20% to 60% of the transmittance in the above-mentioned range when the carboxyl groups were not condensed.

The negative electrode active material used was an alloy containing 37 wt % of Ti and 63 wt % of Si. This negative electrode active material was prepared by mechanical alloying. Electron diffraction of this alloy in a transmission electron microscope confirmed that the alloy has a TiSi₂ phase and a Si phase.

(Preparation of Positive Electrode)

Lithium cobaltate (LiCoO₂) serving as a positive electrode active material was mixed with acetylene black as a conductive agent, polytetrafluoroethylene as a binder, and water as a dispersion medium in a predetermined ratio. The resultant mixture was mixed to form a positive electrode mixture slurry. The slurry was applied onto both sides of a current collector made of a 20-μm-thick aluminum foil, dried and rolled to prepare a positive electrode. The positive electrode had a thickness of 180 μm.

In order to achieve a good capacity balance, the thickness of the positive and negative electrodes was adjusted by controlling the amount of the electrode mixture slurry applied.

(Fabrication of Battery)

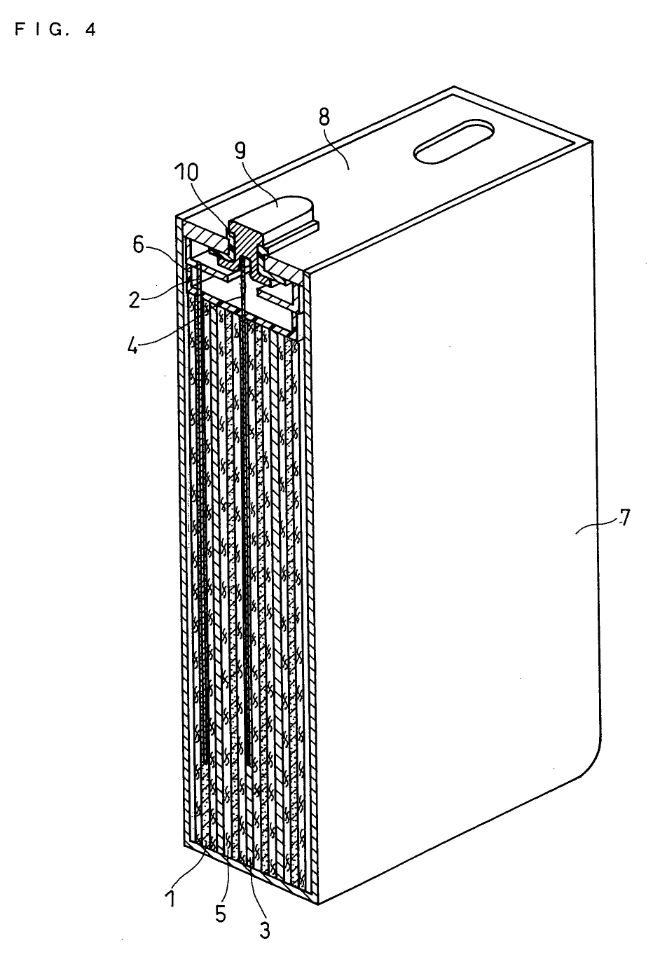

A prismatic battery as illustrated in FIG. 4 was fabricated. The prismatic battery had a thickness of 5 mm, a width of 34 mm, and a height of 36 mm. This battery thickness of 5 mm was determined in consideration of expansion of the active material during charge.

The battery as illustrated in FIG. 4 was produced in the following manner.

An electrode assembly was fabricated by winding a positive electrode 1, a negative electrode 3, and a separator 5 interposed between the positive electrode 1 and the negative electrode 3. One end of an aluminum positive electrode lead 2 was welded to the positive electrode 1. One end of a nickel negative electrode lead 4 was welded to the negative electrode 3. The separator 5 was a porous polyethylene sheet with a thickness of 20 μm.

The electrode assembly was inserted into an aluminum battery case 7. A polyethylene resin frame 6 was mounted on the electrode assembly. The other end of the positive electrode lead 2 was spot welded to the lower face of a sealing plate 8. The other end of the negative electrode lead 4 was electrically connected to the lower part of a nickel negative electrode terminal 9, which was inserted into a terminal hole in the middle of the sealing plate, with an insulating material 10 interposed therebetween. The battery case 7 had a thickness of 5 mm, a width of 34 mm, and a height of 36 mm, and the thickness of the material constituting the battery case was 0.2 μm.

The open edge of the battery case and the edge of the sealing plate were welded together by a laser, and a predetermined amount of a non-aqueous electrolyte was injected therein from the injection hole of the sealing plate (not shown). Lastly, the injection hole was closed with an aluminum sealing stopper (not shown), and the injection hole was sealed by laser welding to complete a battery. The non-aqueous electrolyte was prepared by dissolving lithium hexafluorophosphate (LiPF₆) at a concentration of 1 mol/L in a solvent mixture of ethylene carbonate and ethyl methyl carbonate in a volume ratio of 1:1.

Using the negative electrodes “a” to “f”, lithium ion secondary batteries were produced in the same manner as the above and designated as batteries 1 to 6. The batteries 1 and 2 are comparative batteries.

(Batteries 7 to 12)

Batteries 7 to 12 were produced in the same manner as the batteries 1 to 6 except for the use of polymethacrylic acid as the binder in place of polyacrylic acid. The batteries 7 to 8 are comparative batteries.

[Evaluation]

(Battery Thickness at the 1st Cycle and Capacity Retention Rate)

Each of the batteries 1 to 12 was charged at a current of 80 mA until the battery voltage reached 4.2 V, and the charged battery was discharged until the battery voltage dropped to 2.5 V. This charge/discharge cycle was repeated 100 times.

After the 1st charge/discharge cycle, the battery thickness was measured (battery thickness at the 1st cycle). Table 1 shows the results.

The percentage of the discharge capacity at the 100th cycle relative to the discharge capacity at the 1st cycle was obtained as a capacity retention rate. Table 1 shows the results.

TABLE 1

| | | | Presence or | | |
|---|---|---|---|---|---|
| | | | absence of | Battery | |
| | | Temperature | infrared | thickness | Capacity |
| | | of heat | absorption | at the | retention |
| | | treatment | spectrum | 1st cycle | rate |
| | Binder | (° C.) | peak | (mm) | (%) |
| Comp. | A | 60 | X | 5.9 | 65 |
| battery 1 | | | | | |
| Comp. | A | 110 | X | 5.7 | 74 |
| battery 2 | | | | | |
| Battery 3 | A | 150 | ◯ | 5.1 | 91 |
| Battery 4 | A | 190 | ◯ | 5.0 | 93 |
| Battery 5 | A | 200 | ◯ | 5.0 | 90 |
| Battery 6 | A | 210 | ◯ | 5.1 | 82 |
| Comp. | B | 60 | X | 5.8 | 63 |
| battery 7 | | | | | |
| Comp. | B | 110 | X | 5.6 | 73 |
| battery 8 | | | | | |
| Battery 9 | B | 150 | ◯ | 5.1 | 90 |
| Battery 10 | B | 190 | ◯ | 5.0 | 91 |
| Battery 11 | B | 200 | ◯ | 5.0 | 89 |
| Battery 12 | B | 210 | ◯ | 5.1 | 80 |

A: Polyacrylic acid
B: Polymethacrylic acid

As shown in Table 1, in the case of the batteries 3 to 4 and 9 to 10 that were prepared by heat-treating the binder at 150° C. or more and less than 200° C., their battery thicknesses at the 1st cycle were almost equal to the battery thickness immediately after the battery production. Also, their capacity retention rates were good.

On the other hand, in the case of the comparative batteries 1 to 2 and 7 to 8 that were prepared by heat-treating the negative electrode sheet at temperatures of less than 150° C., their battery thicknesses at the 1st cycle increased significantly and exceeded 5.5 mm. This is probably due to the evolution of gas caused by decomposition of water remaining in the negative electrode. The battery thicknesses of more than 5.5 mm are not preferable in view of the damage caused to the device powered by the battery.

Further, comparative batteries 1 to 2 and 7 to 8 exhibited low capacity retention rates. This is probably because their battery capacities were lowered by water-related side reaction. When the negative electrode sheet, i.e., the binder, was heat-treated at temperatures less than 150° C., no infrared absorption peak appeared in the range of 980 cm⁻¹ to 1100 cm⁻¹.

With respect to the batteries 5 to 6 and 11 to 12 that were prepared by heat-treating the negative electrode at temperatures of 200° C. or more, their battery thicknesses at the 1st cycle did not increase so much. The capacity retention rates of these batteries were slightly lower than those of the batteries 3 to 4 and 9 to 10. The reason is probably as follows. When the heating temperature is too high, part of the binder is decomposed, so that the adhesive properties deteriorate. Thus, the binder cannot sufficiently bond the particles of the negative electrode active material together and/or bond the negative electrode active material to the negative electrode current collector, thereby resulting in poor current collection.

In this example, the heat-treatment was performed after the rolling. However, even if the heat-treatment is performed before the rolling and even if the heat-treatment is performed without performing rolling, essentially the same effects can be obtained.

### EXAMPLE 2

Batteries 13 to 18 were produced in the same manner as the battery 4 except for the use of M¹-Si alloy powder (M¹ is at least one selected from the group consisting of Fe, Co, Ni, and Cu), or M²-Sn alloy powder (M² is at least one selected from the group consisting of Ti and Cu), shown in Table 2, as the negative electrode active material. In producing the batteries 13 to 18, polyacrylic acid was used as the binder, and the heat-treatment temperature of the negative electrode sheet was 190° C.

Batteries 19 to 24 were produced in the same manner as the batteries 13 to 18 except for the use of polymethacrylic acid as the binder.

The alloy powders were prepared by mechanical alloying in the same manner as in Example 1. Electron diffraction in a transmission electron microscope confirmed that the M¹-Si alloys have a M¹Si₂ phase and a Si phase. Also, it confirmed that the M²-Si alloys have a M²₆Sn₅ phase and a Sn phase.

Using the batteries 13 to 24, the battery thickness at the 1st cycle and capacity retention rate were measured in the same manner as in Example 1. Table 2 shows the results.

TABLE 2

| | | | Battery | |
|---|---|---|---|---|
| | | Composition of | thickness | Capacity |
| | | negative electrode | at the 1st | retention |
| | | active material | cycle | rate |
| | Binder | alloy | (mm) | (%) |
| Battery 13 | A | Fe 37 wt %—Si 63 wt % | 5.0 | 91 |
| Battery 14 | A | Co 38 wt %—Si 62 wt % | 5.0 | 92 |
| Battery 15 | A | Ni 38 wt %—Si 62 wt % | 5.0 | 92 |
| Battery 16 | A | Cu 39 wt %—Si 61 wt % | 5.0 | 90 |
| Battery 17 | A | Ti 26 wt %—Sn 74 wt % | 5.0 | 91 |
| Battery 18 | A | Cu 31 wt %—Sn 69 wt % | 5.0 | 92 |
| Battery 19 | B | Fe 37 wt %—Si 63 wt % | 5.0 | 91 |
| Battery 20 | B | Co 38 wt %—Si 62 wt % | 5.0 | 92 |
| Battery 21 | B | Ni 38 wt %—Si 62 wt % | 5.0 | 92 |
| Battery 22 | B | Cu 39 wt %—Si 61 wt % | 5.0 | 90 |
| Battery 23 | B | Ti 26 wt %—Sn 74 wt % | 5.0 | 91 |
| Battery 24 | B | Cu 31 wt %—Sn 69 wt % | 5.0 | 92 |

A: Polyacrylic acid
B: Polymethacrylic acid

As shown in Table 2, even when the above-mentioned M¹-Si alloys or M²-Sn alloys were used as the negative electrode active materials, the battery thickness at the 1st cycle did not increase, because of the use of the binders in which part of the carboxyl groups were condensed. Also, the capacity retention rates were high.

### EXAMPLE 3

Batteries 25 to 27 were produced in the same manner as the battery 4 except that a Ti—Si alloy was used as the negative electrode active material and the composition of the Ti—Si alloy was varied as shown in Table 3. In producing the batteries 25 to 27, polyacrylic acid was used as the binder, and the heat-treatment temperature of the negative electrode sheet was 190° C.

Batteries 28 to 30 were produced in the same manner as the batteries 25 to 27 except that polymethacrylic acid was used as the binder.

The Ti—Si alloy powders of various compositions were prepared by mechanical alloying in the same manner as in Example 1. Electron diffraction in a transmission electron microscope confirmed that the Ti—Si alloys have a TiSi₂ phase and a Si phase.

Using the batteries 25 to 30, the battery thickness at the 1st cycle and capacity retention rate were measured in the same manner as in Example 1. Table 3 shows the results.

TABLE 3

| | | | Battery | |
|---|---|---|---|---|
| | | Composition of | thickness | Capacity |
| | | negative electrode | at the | retention |
| | | active material | 1st cycle | rate |
| | Binder | alloy | (mm) | (%) |
| Battery 25 | A | Ti 9 wt %—Si 91 wt % | 5.0 | 88 |
| Battery 26 | A | Ti 23 wt %—Si 77 wt % | 5.0 | 91 |
| Battery 27 | A | Ti 41 wt %—Si 59 wt % | 5.0 | 95 |
| Battery 28 | B | Ti 9 wt %—Si 91 wt % | 5.0 | 87 |
| Battery 29 | B | Ti 23 wt %—Si 77 wt % | 5.0 | 89 |
| Battery 30 | B | Ti 41 wt %—Si 59 wt % | 5.0 | 93 |

A: Polyacrylic acid
B: Polymethacrylic acid

As shown in Table 3, even when the Ti—Si alloys of various compositions were used as the negative electrode active materials, the battery thickness at the 1st cycle did not increase because of the use of the binders in which part of the carboxyl groups were condensed. Also, the capacity retention rates were high.

### EXAMPLE 4

Batteries 31 to 34 were produced in the same manner as the battery 4 except that Si, Sn, SiO, and SnO were used as the negative electrode active material, respectively. In producing the batteries 31 to 34, polyacrylic acid was used as the binder, and the heat-treatment temperature of the negative electrode sheet was 190° C.

Batteries 35 to 38 were produced in the same manner as the batteries 31 to 34 except for the use of polymethacrylic acid as the binder.

Using the batteries 31 to 38, the battery thickness at the 1st cycle and capacity retention rate were measured in the same manner as in Example 1. Table 4 shows the results.

TABLE 4

| | | | Battery | |
|---|---|---|---|---|
| | | Negative | thickness at | Capacity |
| | | electrode | the 1st | retention |
| | | active | cycle | rate |
| | Binder | material | (mm) | (%) |
| Battery 31 | A | Si | 5.2 | 90 |
| Battery 32 | A | Sn | 5.2 | 90 |
| Battery 33 | A | SiO | 5.1 | 91 |
| Battery 34 | A | SnO | 5.1 | 91 |
| Battery 35 | B | Si | 5.2 | 90 |
| Battery 36 | B | Sn | 5.2 | 90 |
| Battery 37 | B | SiO | 5.1 | 90 |
| Battery 38 | B | SnO | 5.1 | 90 |

A: Polyacrylic acid
B: Polymethacrylic acid

As shown in Table 4, even when the above-mentioned negative electrode active materials were used, an increase in the battery thickness at the 1st cycle was suppressed because of the use of the binders in which part of the carboxyl groups were condensed. Also, the capacity retention rates were good.

Also, even when SiOₓ where 0<x<2 or SnO_{y} where 0<y<2 is used as the negative electrode active material, an increase in the battery thickness at the 1st cycle can be suppressed and good capacity retention rate can be obtained by using a binder in which part of the carboxyl groups are condensed.

The lithium ion secondary battery of the present invention has high energy density and excellent characteristics. Therefore, the lithium ion secondary battery of the present invention can be used, for example, as the power source for personal digital assistants, portable electronic appliances, small-sized power storage devices for home use, two-wheel motor vehicles, electric vehicles, and hybrid electric vehicles.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A negative electrode for a lithium ion secondary battery, comprising a negative electrode active material layer,
wherein said negative electrode active material layer comprises a negative electrode active material capable of reversibly absorbing and desorbing lithium, and a binder,
said binder comprises at least one polymer selected from the group consisting of polyacrylic acid and polymethacrylic acid, and
said polymer comprises an acid anhydride group.

2. The negative electrode for a lithium ion secondary battery in accordance with claim 1, wherein said negative electrode active material comprises at least one element selected from the group consisting of Si and Sn.

3. The negative electrode for a lithium ion secondary battery in accordance with claim 2, wherein said negative electrode active material comprises at least one selected from the group consisting of simple substance Si and simple substance Sn.

4. The negative electrode for a lithium ion secondary battery in accordance with claim 2, wherein said negative electrode active material comprises at least one selected from the group consisting of SiOₓ where 0<x<2 and SnO_{y} where 0<y<2.

5. The negative electrode for a lithium ion secondary battery in accordance with claim 2, wherein said negative electrode active material comprises an alloy material comprising Si and at least one element selected from the group consisting of Ti, Fe, Co, Ni and Cu.

6. The negative electrode for a lithium ion secondary battery in accordance with claim 5, wherein said alloy material comprises a TiSi₂ phase and a Si phase.

7. A lithium ion secondary battery comprising the negative electrode of claim 1, a positive electrode, a separator, and a non-aqueous electrolyte.
